(19) United States
(12) Patent Application Publication
(10) Pub. No.: US 2019/0358594 A1
(43) Pub. Date: Nov. 28, 2019

(54) MEMBRANE MODULES

(71) Applicant: OASYS WATER, LLC, Dover, DE (US)

(72) Inventors: Eric Maxwell, Charlestown, MA (US); Inga B. Elkina, Wilmington, MA (US); Nathan T. Hancock, Boston, MA (US); Gary McGurgan, St. Louis Park, MN (US)

(21) Appl. No.: 15/860,997

(22) Filed: Jan. 3, 2018

Related U.S. Application Data
(63) Continuation of application No. 14/204,433, filed on Mar. 11, 2014, now abandoned.
(60) Provisional application No. 61/793,184, filed on Mar. 15, 2013.

(51) Int. Cl. B01D 69/14; B01D 63/08; B01D 71/56; C02F 1/44; B01D 61/00; B01D 63/10

(52) U.S. Cl. CPC B01D 69/148; B01D 63/082; B01D 71/56; C02F 2103/08; B01D 61/002; B01D 63/103; B01D 2313/143; C02F 1/445

(57) ABSTRACT

The invention relates to membranes, membrane modules, and applications therefor. In particular, the invention relates to the construction of membranes and membrane modules for use in osmotically driven membrane processes.

### CROSS-REFERENCE TO RELATED APPLICATIONS

This application claims priority to and the benefit of U.S. Provisional Patent Application No. 61/793,184, filed Mar. 15, 2013; the entire disclosure of which is hereby incorporated by reference herein in its entirety.

### FIELD OF THE INVENTION

The invention generally relates to membranes and membrane modules and more particular the manufacture and arrangement of membrane modules and uses therefor.

### BACKGROUND

Membrane-based fluid separation systems (for example, osmosis and pervaporation) are generally known in the prior art. Typically, these systems include a number of components that are plumbed together, which can increase the complexity and overall size of the systems. Additionally, needing to plumb the various components together results in the need for still more components (e.g., valves, fittings, etc.) and results in additional drawbacks for such systems (e.g., additional component costs and plumbing leaks).

Furthermore, those conventional systems tend to be arranged for single applications (e.g., a single pass or type of process). So in cases where multiple processes need to be performed and/or additional stages of a single type of process are desired, additional componentry and plumbing is required, again adding to the complexity and size of the systems. Specifically, multiple modules would need to be plumbed in series and/or parallel to suit a particular application, and once constructed, would not be easy to modify to, for example, accommodate a change in the system's requirements or repair a defect.

Additionally, the membranes used in the afore-mentioned fluid separation systems/processes typically include a thin film barrier layer disposed on a porous support layer. Traditionally, the membrane layers have been manufactured to suit a particular application and via traditional processes. See, for example, U.S. Pat. No. 7,882,963, the disclosure of which is hereby incorporated by reference herein in its entirety. Generally, membranes are put in service, and other than periodic cleaning, perform their intended functions for their useful life. Various modifications can be made to improve the performance of the membranes, for example, the incorporation of nanoparticles into a layer of the finished membrane to enhance fouling resistance and improve flux; however, the mere introduction of nanoparticles into a membrane does not automatically improve the performance of a typical membrane for every application. In addition, by virtue of the assembly/arrangement of a forward osmosis membrane module, the various membrane layers can be at risk of being damaged, where the damage can result in the passage of various solutes through the membrane. Accordingly, there remains a need for solutions to improving the performance of membranes, in particular forward osmosis membranes, which operate differently and have different requirements for optimization than conventional membranes (e.g., nanofiltration or reverse osmosis membranes).

### SUMMARY

Generally, the membranes and membrane cartridges/modules described herein can be used alone or in combinations and can be disposed within an enclosed housing or submerged in a tank, either an open or closed tank. In addition, the various membranes can be arranged in plate and frame or spiral wound configurations. Examples of various membrane configurations can be found in U.S. Pat. No. 8,181,794, U.S. Patent Publication No. 2011/0036774, and PCT Publication No. WO2013/022945, the disclosures of which are hereby incorporated by reference herein in their entireties. Furthermore, the various membranes described herein can be incorporated into a variety of osmotically driven membrane systems/processes. Examples of osmotically driven membrane processes are disclosed in U.S. Pat. Nos. 6,391,205 and 7,560,029; and U.S. Patent Publication Nos. 2012/0067819, 2011/0203994, 2012/0273417, and 2012/0267306; the disclosures of which are hereby incorporated herein by reference in their entireties.

In one aspect, the invention relates to a forward osmosis membrane module. The forward osmosis membrane module includes a membrane sheet comprising at least a support layer and a barrier layer disposed thereon, a first mesh screen disposed adjacent to the barrier layer of the membrane sheet, a second mesh screen disposed proximate the support layer of the membrane sheet, and a protective layer disposed between the second mesh screen and the support layer of the membrane sheet. The protective layer reduces or eliminates contact between the second mesh screen and the support layer of the membrane sheet. The membrane sheet is configured for passing a solvent therethrough via forward osmosis principles.

In various embodiments of the foregoing aspect of the invention, the protective layer expands over substantially an entire surface of the barrier layer and includes a nonwoven fabric layer having a thickness of about 1.5 mils to about 20 mils. The protective layer can be made from polyethylene terephthalate (PET) or similar material. In some embodiments, the protective layer has a basis weight of about 50 to about 100 g/m² and/or a Frazier air permeability of about 100 to about 1000 cfm/ft². In one or more embodiments, the first mesh screen has a thickness of about 0.020 inches with a strand spacing of 16 strands per inch and a strand orientation of 90 degrees, and the second mesh screen has a thickness of about 0.034 inches with a strand spacing of 18 strands per inch and a strand orientation of 90 degrees. One or more of the first mesh screen, the second mesh screen, or the protective layer can be secured to the membrane sheet via an adhesive, such as a small amount glue about the periphery of the membrane so as not to interfere with the active area of the membrane. Heat sealing and/or sonic welding are also contemplated. In various embodiments, the membrane module can be wrapped around a center tube to form a spiral would membrane assembly.

In another aspect, the invention relates to a membrane assembly including a forward osmosis membrane module and a housing at least partially enclosing the forward osmosis membrane module. The forward osmosis membrane module includes a membrane sheet having at least a support layer and a barrier layer disposed thereon, a first mesh screen disposed adjacent to the barrier layer of the membrane sheet, a second mesh screen disposed proximate the support layer of the membrane sheet, and a protective layer disposed between the second mesh screen and the support layer of the membrane sheet. The protective layer reduces or eliminates contact between the second mesh screen and the support layer of the membrane sheet. The membrane sheet is configured for passing a solvent therethrough via forward osmosis principles. The housing can include means for fluid ingress and fluid egress. In addition, the housing can be a vessel that completely encloses the membrane module in, for example, a spiral wound or plate and frame configuration. Alternatively, the housing can be configured to only partially enclose the membrane module or may consist of a skeleton or framework for holding the modules together for use in an immersed application.

In various embodiments of the foregoing aspect, the means for fluid ingress include a first inlet for introducing a feed solution to one side of the membrane module and a second inlet for introducing a draw solution to an opposite side of the membrane module. The means for fluid egress include a first outlet for discharging a concentrated feed solution from one side of the membrane module and a second outlet for discharging a dilute draw solution from the opposite side of the membrane module. In one or more embodiments, the housing is a pressure vessel and the membrane module is wrapped around a center tube to form a spiral wound membrane assembly. In an alternative embodiment, the membrane module has a substantially planar configuration and is assembled in a plate and frame configuration.

In another aspect, the invention relates to a forward osmosis membrane with improved rejection characteristics. The membrane includes a substantially planar substrate, a polymeric support layer disposed on the substantially planar substrate, and a polymeric barrier layer disposed on the polymeric support layer. The barrier layer includes a plurality of layered double hydroxide nanoparticles substantially evenly dispersed within the barrier layer. Generally, the phrase “evenly dispersed” is used to denote that the nanoparticles have not settled onto the polymeric support layer, but instead are generally situated above the junction between the support layer and the barrier layer. In some embodiments, a surfactant can be added to the first bath with the nanoparticles to prevent the nanoparticles from stratifying in the top or bottom layers.

In various embodiments of the foregoing aspect, the substantially planar substrate can include a polymeric paper or other type of non-woven substrate. The support and barrier layers can be deposited onto the membrane assembly via, for example, interfacial polymerization or other suitable means. In one or more embodiments, the layered double hydroxide nanoparticles comprise flakes of Mg/Al-LDH, for example, MgₙAlₙ₋₁(OH)₂. The nanoparticle flakes may include a longitudinal axis and the longitudinal axes are oriented horizontally or in parallel relative to the barrier layer (i.e., the flakes essentially lie “flat” within the barrier layer). In various embodiments, the layered double hydroxide nanoparticles include Magnesium (Mg) and Aluminum (Al) in a ratio of about 1:1 to about 10:1. In a particular embodiment, the ratio is 3:1.

In yet another aspect, the invention relates to a method of manufacturing a forward osmosis membrane. The method includes the steps of providing a substantially planar substrate, casting a polymeric support layer onto the substantially planar substrate, and casting a polymeric barrier layer onto the polymeric support layer. The barrier layer includes a plurality of layered double hydroxide nanoparticles substantially evenly dispersed within the barrier layer.

In various embodiments of the foregoing aspect, the step of casting the barrier layer includes the steps of introducing the layered double hydroxide nanoparticles into a solvent bath comprising a first monomer, introducing the substantially planar substrate and support layer to the solvent bath, subjecting the substantially planar substrate and support layer to means for dispersing the layered double hydroxide nanoparticles, introducing the substantially planar substrate and support layer to a second bath, wherein the second bath comprises a second monomer, and reacting the monomers to form the barrier layer and set the nanoparticles in place within the barrier layer. The means for dispersing can include subjecting the solvent bath to an energy field, such as ultrasonic, electro-magnetic, or thermal, applied constantly or in a pulsed manner. The means for dispersing can be applied to the solvent bath continuously as the membrane substrate and support layer are passed therethrough. Alternatively or additionally, the means for dispersing can be applied directly to the membrane substrate, for example, as it passes from the first bath to the second bath.

In additional aspects, the invention relates to forward osmosis membrane systems and/or methods of facilitating a forward osmosis separation operation that may include any of the membrane modules described herein.

Osmotic separation processes generally involve generating water flux across a semipermeable membrane based on osmotic pressure differentials. Solute may be rejected by the membrane and retained on either side due to the greater permeability of water than the solute with respect to the selective barrier of the membrane. Solutes may be undesirable and therefore removed from a process stream via membrane separation for purification, or desirable in which case they may be concentrated and collected via a membrane separation process. Membranes may be used in various osmotically driven separation processes, such as but not limited to desalination, wastewater purification and reuse, FO or PRO bioreactors, concentration or dewatering of various liquid streams, concentration in pharmaceutical and food-grade applications, PRO energy generation and energy generation via an osmotic heat engine.

Typically, polymeric membranes typically include a porous support structure that provides mechanical and structural support for a selective layer. Membranes may be formed in various shapes including spiral wound, hollow fiber, tubular and flat sheet depending on an intended application. Membrane characteristics should be customized to achieve ideal performance and may vary between specific applications. For example, in FO and PRO applications, the effectiveness of a separation process may be enhanced by reducing the thickness and tortuosity of the membrane, while increasing its porosity and hydrophilicity, without sacrificing strength, salt rejection, and water permeability properties.

A selective (i.e., barrier) or otherwise active layer may be applied to the support material of a substrate during a membrane manufacturing process. In some embodiments, a semipermeable layer may be applied as the active layer. The semipermeable layer may comprise a polymer. In certain embodiments, the semipermeable layer may comprise a polyamide, such as polyamide urea, a block co-polymer, or polypiperazine. In some non-limiting embodiments, a polysulfone layer may be applied to a PET support layer of a bilayer substrate.

The substrate material may be conveyed to a polymer application device which applies a solution of polymer, for example polysulfone, in a solvent, for example dimethylformamide. Upon coating, the substrate may enter a quenching bath in which the polymer precipitates into the top layer of the bilayer material. The temperature of the quenching bath may vary and may impact one or more properties of a resultant membrane. In at least some preferred non-limiting embodiments, improved properties of forward osmosis membranes may be associated with quenching bath temperature in the range of 100° F. to 110° F.

In accordance with one or more embodiments, the selective barrier in the disclosed thin-film composite membranes may be a semipermeable three-dimensional polymer network, such as an aliphatic or aromatic polyamide, aromatic polyhydrazide, poly-bensimidazolone, polyepiamine/amide, polyepiamine/urea, polyethyleneimine/urea, sulfonated polyfurane, polybenzimidazole, polypiperazine isophtalamide, a polyether, a polyether-urea, a polyester, or a polyimide or a copolymer thereof or a mixture of any of them. In certain embodiments, the selective barrier may be an aromatic or non-aromatic polyamide, such as residues of a phthaloyl (e.g., isophthaloyl or terephthaloyl) halide, a trimesyl halide, or a mixture thereof. In another example, the polyamide may be residues of diaminobenzene, triaminobenzene, polyetherimine, piperazine or poly-piperazine or residues of a trimesoyl halide and residues of a diaminobenzene. The selective barrier may also comprise residues of trimesoyl chloride and m-phenylenediamine. Further, the selective barrier may be the reaction product of trimesoyl chloride and m-phenylenediamine.

In accordance with one or more embodiments, the selective barrier may be characterized by a thickness adequate to impart desired salt rejection and water permeability properties while generally minimizing overall membrane thickness. In certain embodiments, the selective barrier may have an average thickness from about 50 nm and about 200 nm. The thickness of the barrier layer is desired to be as limited as possible, but also thick enough to prevent defects in the coating surface. The practice of polyamide membrane formation for pressure driven semi-permeable membranes may inform the selection of the appropriate barrier membrane thickness. The selective barrier may be formed on the surface of a porous support via polymerization, for example, via interfacial polymerization.

Polymers that may be suitable for use as porous supports in accordance with one or more embodiments include polysulfone, polyethersulfone, poly(ether sulfone ketone), poly(ether ethyl ketone), poly(phthalazinone ether sulfone ketone), polyacrylonitrile, polypropylene, poly(vinyl fluoride), polyetherimide, cellulose acetate, cellulose diacetate, and cellulose triacetate polyacrylonitrile.

In accordance with one or more embodiments, the support layer may be characterized by a thickness adequate to provide support and structural stability to a membrane during manufacture and use while generally minimizing overall membrane thickness. In certain embodiments, the polymer support may have an average thickness from about 10 μm and to about 75 μm. It is generally desirable for the support to be as thin as possible without compromising the quality of the support surface for interfacial polymerization of the barrier layer. The smoother the support layer is, the less thickness of support material is generally required for this criterion. In at least some preferred embodiments, this layer is less than approximately 40 μm. In certain embodiments, the porous support comprises a first side (active side) with a first plurality of pores, and a second side (support side) with a second plurality of pores. In certain embodiments, the first plurality of pores and the second plurality of pores are fluidly connected to each other. In one embodiment, polymeric additives are dispersed within the porous support. Additives may enhance hydrophilicity, strength or other desirable properties.

A desired degree of cross-linking may be achieved within the active layer, such as to improve the barrier properties of the membrane. Inducing cross linking in the polyamide layer is generally desirable to improve salt rejection and overall performance. In accordance with one or more embodiments, cross-linking is achieved in a manner such that the hydrophilic materials are not reduced in their performance, and are maintained in a wet state throughout the manufacturing and treatment process. In some embodiments, hot water annealing may be used to facilitate cross-linking. In other embodiments, heat treatment may occur in one or more of the immersion steps of the membrane fabrication process, during or after the active layer deposition or formation process. In other embodiments, chemical treatment may be used. In at least one embodiment, heat drying, such as oven drying, is not used. In some such embodiments, the membranes will readily rewet by immersion in water, and in some embodiments, they will rewet by exposure to a wetting agent in conjunction with water, such that they will be substantially wet when ready for use. In some embodiments, the membranes may be characterized as having a salt rejection of at least 99% or greater. The forward osmosis membranes may generally be relatively thin and characterized by high porosity, low tortuosity, and high wettability. The membranes may find use in a variety of applications including osmotic-driven water purification and filtration, desalination of seawater, purification of contaminated aqueous waste streams, separation of various aqueous streams, osmotic power generation and the like.

In some embodiments, phase inversion of a polymer coated on or around a material intended primarily to give the polymer resistance to deformation with strain may be used to create a membrane support. For example, a very open and thin woven or non-woven material may be surrounded by the polymer, rather than underneath it. Interfacial polymerization of a rejecting polymer may then be carried out on this support structure. In accordance with one or more embodiments, a forward osmosis membrane may be a hydrophilic phase inversion membrane on a woven or non-woven fabric. The hydrophilic material may be PAN in some non-limiting embodiments, alone or mixed with other monomers. The fabric layer may be of any desired thickness. In some non-limiting embodiments, the fabric may be about 25 micrometers in thickness. The forward osmosis membrane may be further characterized by polyamide interfacial polymerization on its surface. A polyamide active layer may be applied so as to result in a membrane of any desired thickness. In some non-limiting embodiments, the membrane may be approximately 25 micrometers thick. The active layer of the forward osmosis membrane may be modified to enhance rejection of draw solutes. The support film may be nonwoven and made of any material, but thinness, high porosity, low tortuosity, and hydrophilicity are generally desirable. The thickness of the support film may vary. In some embodiments, the support film may be less than about 100 micrometers, less than about 80 micrometers, less than about 50 micrometers or thinner. In at least one embodiment, a porous polyester nonwoven support film may be used as a substrate.

In accordance with one or more embodiments, a forward osmosis membrane may be formed by first creating a support layer. In some non-limiting embodiments, a thin fabric backing layer of less than about 30 micrometers may be coated with a polysulfone solution of about 10% to about 20%, preferably about 12% to 16%, and more preferably about 13.5% to 15% in dimethylformamide. Lower concentrations of polysulfone may be used to further improve forward osmosis membrane properties, including flux. In some embodiments, the amount of polysulfone coating may generally be less than about 16 g/m2 to minimize the impact of the support layer on diffusion. The resulting support layer precursor may then be immersed in room temperature water causing the phase inversion of the polymer. Immersion in temperatures greater than 90° F. may be used to improve the pore size characteristics of the support layer. This may produce a thin, micro-porous, open support structure with an embedded web giving the polymer strength for rolling and handling. The active layer may then be applied to the support structure. One example of the coating of this support structure with the active layer would be the immersion of the support in a solution containing polyamide or other desired active material. In one embodiment, the support structure may be immersed in a 3.4% solution of 1-3 phenylenediamine in room temperature water. The concentration of the solution may vary based on desired characteristics of the applied active layer. Duration of immersion may also vary. In some embodiments, the duration may be less than about 5 minutes. In one exemplary embodiment, the duration of immersion may be about 2 minutes. Excess solution from the surface of the membrane may be removed, for example with a roller or air knife.

The membrane may then be briefly immersed in another solution to induce the polymerization of the polyamide rejecting layer by combination of the diamine in the aqueous phase and, for example, acid chloride in the non-aqueous phase, at the surface of the support material where the phases meet. In some embodiments, the membrane may be immersed in the solution for about 2 minutes. In one embodiment, a 0.15% solution of 98% 3,5 benzenetricarbonyltrichloride in Isopar® C or G at room temperature may be used. The membrane may then be removed and the Isopar® allowed to evaporate from the membrane for a period of time, for example less than about 5 minutes. In some embodiments, the duration of the evaporation step may be about 2 minutes. In some embodiments, immersion may take the form of a dip coating process, such as one in which substantially only the surface of the membrane comes into contact with a solution. In other embodiments, the entire membrane may be submerged in the bath. In some embodiments, a combination of these techniques may be used, such as in a sequence of different immersion steps. In other embodiments, the heat treatment of the membrane may occur in any or several immersion steps intended for other purposes, such as during or after the active layer polymerization or deposition step.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a perspective view of a membrane module assembly in accordance with one or more embodiments of the invention;

FIGS. 2A and 2B are end and side views of the membrane module of FIG. 1 in partial cross-section;

FIGS. 3A-3D are schematic diagrams of membrane frames in accordance with one or more embodiments of the invention;

FIG. 4 is a schematic diagram of a membrane module array in accordance with one or more embodiments of the invention;

FIG. 5 is a schematic plan view of a membrane module in accordance with one or more embodiments of the invention;

FIG. 5A is a cross-sectional view of the module of FIG. 5 taken at line A-A in accordance with one or more embodiments of the invention;

FIG. 5B is an alternative cross-sectional view of the module of FIG. 5 taken at line A-A in accordance with one or more embodiments of the invention;

FIG. 5C is another alternative cross-sectional view of the module of FIG. 5 taken at line A-A in accordance with one or more embodiments of the invention;

FIGS. 6A-6G are partial cross-sectional views of alternative membrane module structures in accordance with one or more embodiments of the invention;

FIG. 7 is a schematic plan view of an alternative membrane module in accordance with one or more embodiments of the invention;

FIG. 8 is a schematic perspective view of another alternative membrane module in accordance with one or more embodiments of the invention;

FIG. 8A is a partial cross-sectional view of the module of FIG. 8 taken at line A-A in accordance with one or more embodiments of the invention;

FIG. 9 is a schematic plan view of an alternative membrane module in accordance with one or more embodiments of the invention;

FIG. 10 is a partial cross-sectional view of a feed tank with a membrane module installed therein in accordance with one or more embodiments of the invention;

FIG. 11A is a partial exploded view of an arrangement of layers that may form a membrane module in accordance with one or more embodiments of the invention;

FIG. 11B is partial cross-sectional view of the membrane layer arrangement of FIG. 11A in a spiral wound configuration;

FIG. 12 is a graphical representation of an exemplary layered double hydroxide nanoparticle and its formula;

FIGS. 13A and 13B are SEM images of membranes with and without the incorporated nanoparticles in accordance with one or more embodiments of the invention;

FIGS. 14A-14B are enlarged, partial cross-sectional views of membrane barrier and support layers in accordance with one or more embodiments of the invention; and

FIG. 15 is a schematic representation of a portion of the membrane production process in accordance with one or more embodiments of the invention.

### DETAILED DESCRIPTION

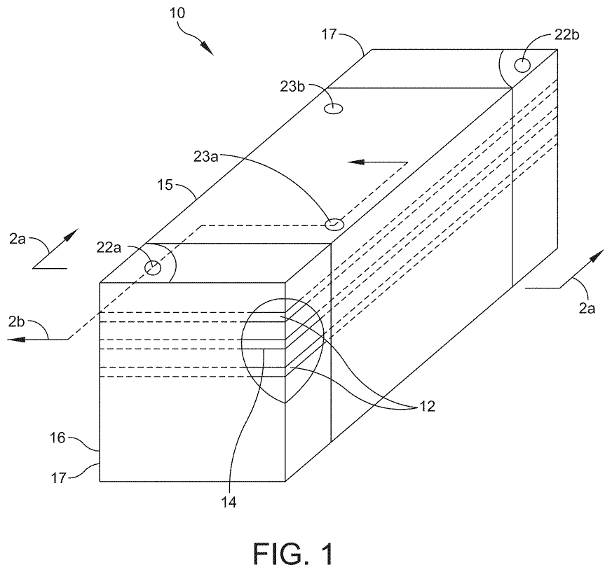

FIG. 1 depicts a perspective view of a membrane module 10 in accordance with one or more embodiments of the invention. The module 10 has a plate and frame type of arrangement and includes a housing 16 and a plurality of membrane plates 12, 14 disposed therein. It is noted that there may be two or more different membrane plate configurations included in any given module to direct the flow of multiple streams through the module; however, the membrane plates may also differ in type to perform different functions depending on the use of the module. For example, modules can include any combination of osmosis membranes, vapor contact membranes, and heat exchange membranes. Additionally, the membrane plates can all be identical where, for example, the module is configured solely for forward osmosis. In one embodiment, the housing 16 includes a central body 15 and bulkheads 17 disposed at each end of the body 15. As shown in FIG. 1, the housing 16 has a substantially rectangular shape; however, other shapes are contemplated and considered within the scope of the invention, for example, cylindrical with domed bulkheads, similar to a typical pressure vessel. The body 15 and bulkheads 17 can be assembled via any known mechanical means, e.g., welded, threaded, or flanged connections. In the case of a threaded connection, the bulkheads 17 can be removed from the body 15 to perform maintenance on the membrane stack (e.g., replace an individual membrane plate) or replace with an alternative bulkhead with, for example, an alternative porting arrangement.

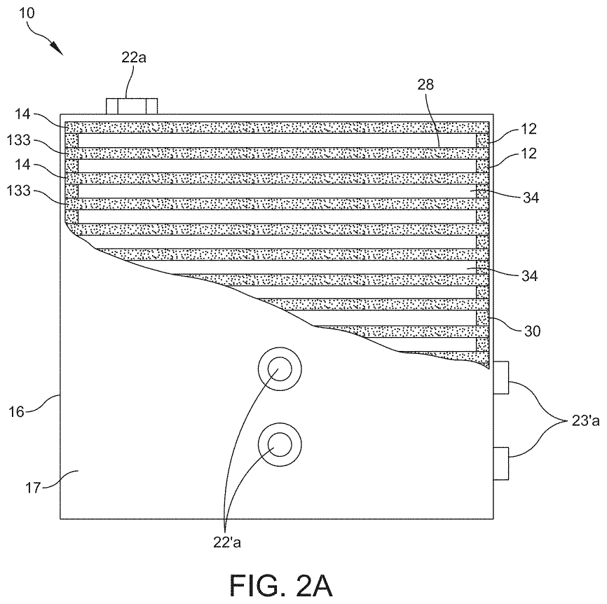

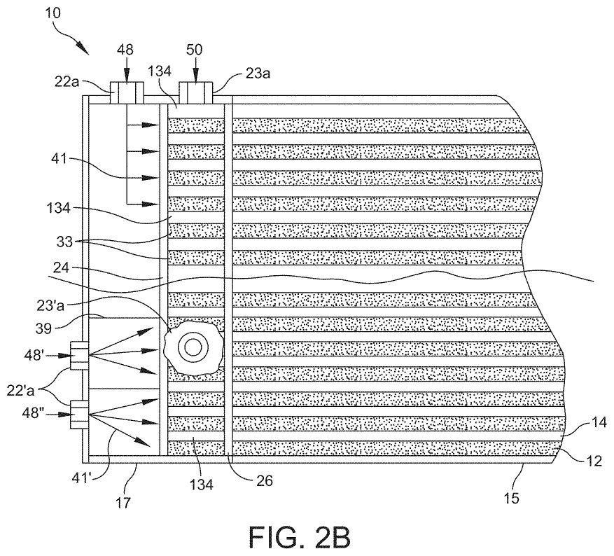

The membrane plates 12, 14 include complimentary shapes and flow paths, as discussed below, and are arranged in an alternating fashion to direct different process streams along predetermined flow paths. The bulkheads 17 and body 15 include a plurality of ports 22, 23 providing inlets and outlets for the various flows. As shown in FIG. 1, the module 10 includes an inlet 22a and an outlet 22b for a first process stream and an inlet 23a and an outlet 23b for a second process stream. In the embodiment shown, the inlets 22a, 23a and outlets 22b, 23b are located in the same general end of the module 10, such that the process streams will flow in the same direction; however, the location of the inlets/outlets for either stream can be reversed to provide a counter flow between the two streams. In some embodiments, the body 15 and/or bulkheads 17 can include additional ports for accommodating additional process streams or for maintenance purposes (e.g., introducing air or a cleaning solution). The ports can be, for example, threaded, flanged, or fitted with quick disconnect fittings. One example of an arrangement of membrane plates 12, 14 and ports 22, 23 is shown in FIGS. 2A and 2B.

FIG. 2A depicts an end view of the membrane module 10 of FIG. 1 with a portion of one bulkhead 17 removed to illustrate the membrane plate arrangement. FIG. 2B depicts a partial side view of the membrane module 10 in cross-section. As can be seen, the module 10 includes alternating membrane plates 12, 14 secured within the housing, either directly or via end plates 24, 26. The membrane module 10 shown includes two inner end plates 26 and two outer end plates 24, which are sealed to the housing 16 and/or bulkhead 17 about their periphery. For example, in one embodiment, the inner end plates 26 can be sealed to the end openings 19 of the body 15 of the housing 16 and include openings through which the various membrane plates 12, 14 pass. The membrane plates are sealed (e.g., via welding or other mechanical means so that a gas or liquid (e.g., an aqueous or non-aqueous solution) can only flow between particular membrane plates as determined by ports in the housing body 15 and/or bulkheads 17 and the membrane plate porting. In one or more embodiments, the outer end plates 24 can be disposed within the bulkheads 17 and sealed about their peripheries therein. The outer end plates 24 can also include openings that allow the membrane plates to pass therethrough. The membrane plates also sealingly engage the outer end plates 24 so as to direct the flow of a liquid or gas between particular membrane plates based on the porting in the bulkheads 17 and the membrane plate porting. In alternative embodiments, additional end plates can be used in conjunction with additional ports to direct more than two different flows through the membrane module 10.

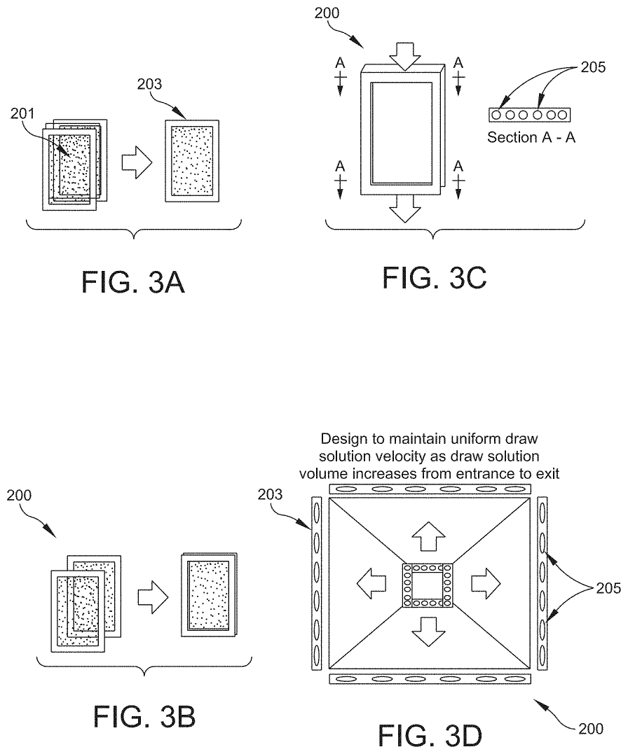

In accordance with one or more embodiments, the membranes are configured in a flat sheet forward osmosis membrane module design 200. A flat sheet membrane envelope may facilitate draw solution flow inside a membrane envelope. A membrane sheet 201 may be glued between two plastic frames 203 that provide structural support as illustrated in FIG. 3A. Alternatively, the membranes may be directly heat sealed to the frames. Two membrane frames may be combined into one membrane envelope as illustrated in FIG. 3B. The frames 203 may be designed so that a row of orifices 205 are created at opposite ends of the frame 203 to facilitate uniform distribution and collection of draw solution within the envelope, as illustrated in FIG. 3C.

In at least some embodiments, the draw solution may increase substantially in volume as it flows through the envelope as a result of water transport across the membrane. With such a flow configuration, the velocity of the draw solution through the module 200 may increase as the volume increases, which may lead to increased pressure drop and required pumping energy. In accordance with one or more embodiments, a relatively constant draw solution velocity may be beneficially maintained as the volume increases from the inlet to outlet of the module 200. Alternatively, as illustrated in FIG. 3D, the module 200′ may be asymmetric with respect to its internal volume, for example, thicker at the bottom for higher volume flow. Additionally or alternatively, the module may be flexible to a degree.

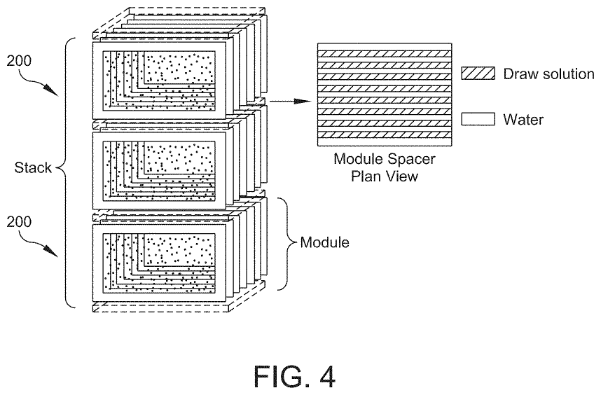

In accordance with one or more embodiments, membrane envelopes may be configured into a module consisting of multiple envelopes. Final spacing between envelopes and the dimensions of the module may be determined during product development. For example, in one non-limiting embodiment, three envelopes per inch of module width may be used for estimating membrane area per unit volume. With respect to FIG. 4, multiple modules 200 may be arrayed vertically into a stack assembly, with a plastic support frame between each module designed to allow vertical flow of both water and draw solution. Overall individual module and stack dimensions may be determined based on factors including ease of handling during assembly and disassembly and/or removal from a membrane tank. Modules, spacers, and stacks may be designed to maintain feed and draw solution hydraulic characteristics.

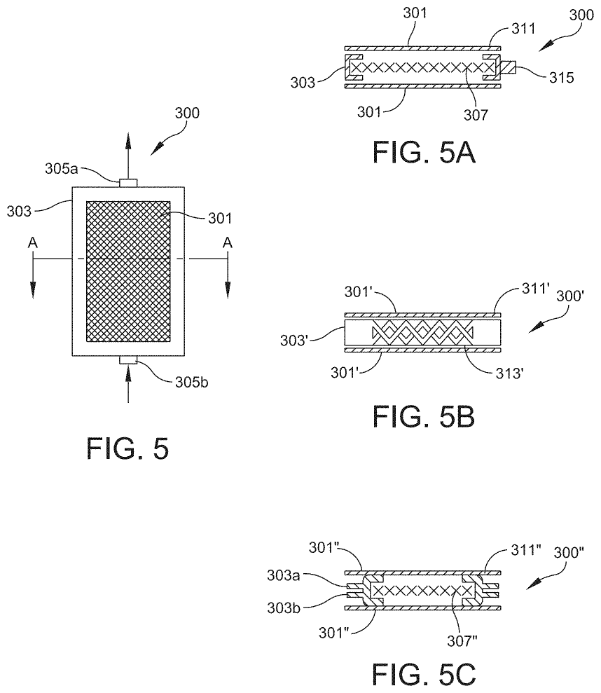

FIG. 5 depicts another embodiment of a membrane module 300 formed of a frame 303 and one or more membrane sheets 301. The frame is shown as rectangular, but could be any shape or combination of shapes to suit a particular application. As shown in FIG. 5, the frame is made of polycarbonate; however other polymers (e.g., PVC, PS, or PET) or various metals can be selected to suit a particular application (e.g., material compatibility). In some embodiments, square tubing or C-shaped channels are used, however, thermoformed plates of suitable thickness can be used. The frame 303 also includes two ports 305a, 305b (e.g., and inlet and an outlet), for the introduction and removal of a solution, for example, a draw solution exposed to the permeate side(s) of the membrane sheets. In alternative embodiments, the ports 305 can be manifold arrangements including one or more ports and can extend along (or be formed within) a portion or all of the top, bottom, or sides of the frame 303.

FIGS. 5A, 5B, and 5C depict in cross-section some of the possible frame and membrane arrangements. As shown in FIG. 5A, the frame 303 has a generally square, C-shaped cross-section and includes four pieces (top, bottom, and 2 sides) welded or otherwise joined together to form the frame 303. Captured within the frame 303 is a spacer 307 (typically a screen) that can be secured to the frame 303 via bonding (e.g., welding or adhesive) or mechanical fasteners. In some embodiments, the spacer 307 is free floating within the frame 303 and/or can be slid into the frame during assembly of the module/cartridge.

As also shown in FIG. 5A, the module 300 includes two membrane sheets 301 attached to each side of the frame 303. In one or more embodiments, the membrane 301 is secured to the frame 303 by thermally bonding the membrane thereto by sonic welding. Alternatively, the membrane 301 can be attached via solvent bonding, adhesive, or a mechanical fastening means (e.g., an additional frame and fasteners), so long as the entire perimeter 311 of the membrane sheet 301 is sealed to the frame 303. Typically, the membrane sheets 301 will be oriented so that the same sides will be facing the interior of the frame 303. For example, if a draw solution is directed through the interior of the module 300, the permeate sides of the membranes 301 will be facing inward. In additional embodiments, the frame/module may include sample ports 315 for monitoring and/or adjusting the composition of the solution flowing through the module 300 and/or attachment means (723, see FIG. 10) for securing and/or interfacing the module 300 with additional modules, a housing, and/or a tank (e.g., an open feed solution tank as shown in FIG. 10).

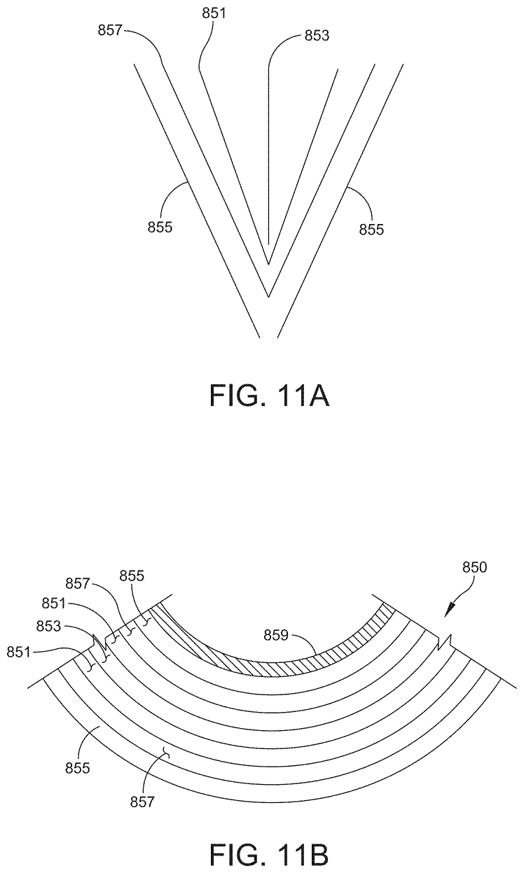

FIG. 5B depicts a module 300′ similar to the module 300 of FIG. 5A; however, the frame 303′ and spacer 307′ are formed as an integral piece via, for example, machining, 3D printing, extrusion, or combinations thereof. Additional layers can be disposed between any of the spacers 307 and membranes 301 described herein. For example, as shown in FIG. 5B, the module 300′ includes a protective layer 313′ disposed between the spacer 307′ and each membrane 301′. In some embodiments, the protective layer 313′ is held captive within the frame 303, and in other embodiments, the layer 313′ is secured to the frame 303′ with the membrane 301. In at least one embodiment, the membrane 301′ and protective layer 313′ are sonically welded to the frame 303 at the same time. Additional details about protective layers are provided hereinbelow with respect to FIGS. 11A and 11B.

In some embodiments, the combined frame 303′ and spacer 307′ can be formed by incorporating (e.g., via injection molding) a molten plastic into the perimeter of a soft mesh screen (i.e., the spacer), where the hardened plastic will form the frame 303′ and be sufficiently rigid that the membrane sheets can be secured thereto (e.g., by sonic welding or heat sealing). The hardened plastic will also allow for the interfacing with additional plates or membrane assemblies and will provide rigidity to the entire assembly. Additionally, the molten plastic can applied to the mesh screen and molded as necessary to also form flow channels, manifolds, and ports that can replace the multiple plates, manifolds, ports, etc. described elsewhere herein.

FIG. 5C depicts yet another module 300″ similar to the module of FIG. 5A. However, in this embodiment, the frame 303″ is made of two separate frames 303a, 303b, joined together via, for example, welding or mechanical means (e.g., fasteners or corresponding structure to enable a snap fit between the frame halves 303a, 303b, with or without a gasket). As with the other modules 300, 300′, the membranes 301″ can be attached to the frame 303″ via welding or other means and include sample ports 315″ and/or protective layers 313″. As shown in FIG. 5C, the frame 303″ is symmetrical.

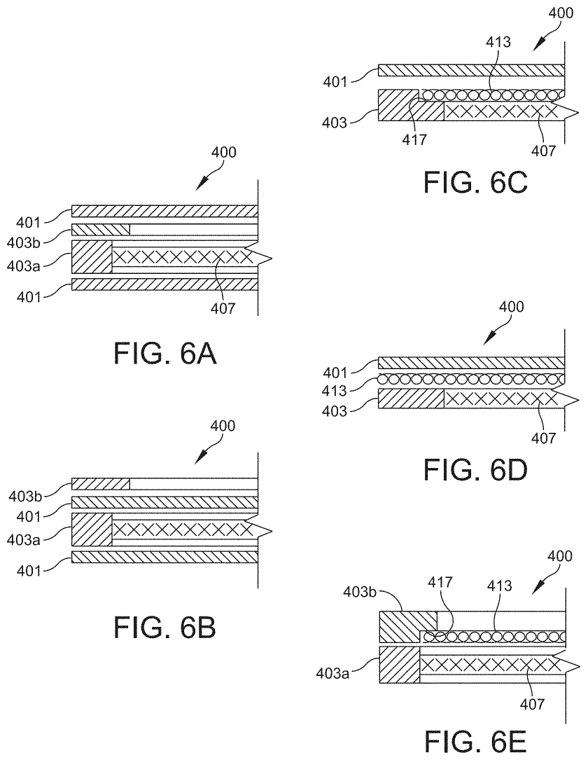

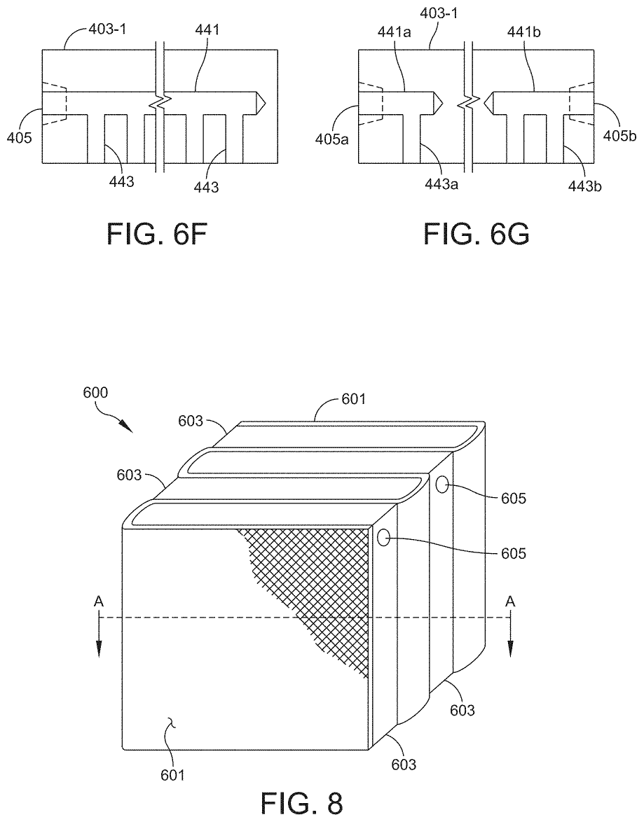

FIGS. 6A-6E depict alternative membrane module 400 constructions. As shown in FIGS. 6A and 6B, the frame 403 is formed of two asymmetrical pieces 403a, 403b. Frame half 403a is similar to those previously described and, in this embodiment is made of pieces of a solid plate. One advantage of the solid frame is that a portion of the frame can be drilled to form the ports and a manifold to feed the interior space of the module with multiple ports, as shown in FIGS. 6F and 6G. The frame includes a second, thinner piece of plate 403b that is wider than frame 403a, thereby forming a barrier to hold the spacer 407 captive. Although the frame 403b is only shown on one side, the module 400 can include an additional frame 403b on the opposite face of frame 403a. Some embodiments will also include the optional protective layer previously described with respect to FIG. 5B. As shown in FIG. 6A, the frame halves 403a, 403b are joined together as previously described with respect to FIG. 5C, and the membrane sheets 401 can be attached to the frame 403 as also previously discussed. Additionally, either frame half 403a, 403b, could include an integrated spacer as previously described with respect to FIG. 5B.

The module 400 of FIG. 6B is similar to the module of FIG. 6A; however, the frame half 403b is disposed on the outside of the membrane 401 and serves to secure the membrane 401 to the frame 403 after the frame halves 403a, 403b are joined together. For example, the two frame halves 403a, 403b and the membrane can all be welded together with the membrane protected between the frame halves. In this embodiment, the membrane 401 on at least one face of the module 400 is captured by the frame 403. Alternatively, the frame 403 can include three pieces so as to capture the membrane 401 on each face of the module 400. In additional embodiments, the frame half 403b can include structure on at least its exterior face that can be used to interface or otherwise secure multiple modules 400, either to each other or a housing.

The module 400 of FIG. 6E is similar to the module of FIG. 6B; however, frame half 403b includes a recessed portion 417 to better accommodate and secure the membrane 401 and a protective layer 413. Although not shown, the module 400 can include the same structure on the opposite face of the frame 403a.

FIGS. 6C and 6D depict modules 400 where the membrane sheets 401 and protective layers 413 are in planar alignment and are co-attached to the frames 403. In FIG. 6C, the frame 403 has a recess 417 on an external face thereof to accommodate the protective layer 413 and/or any additional layers/spacers. Again, the modules 400 can include the same structure on the opposite face of the frames 403.

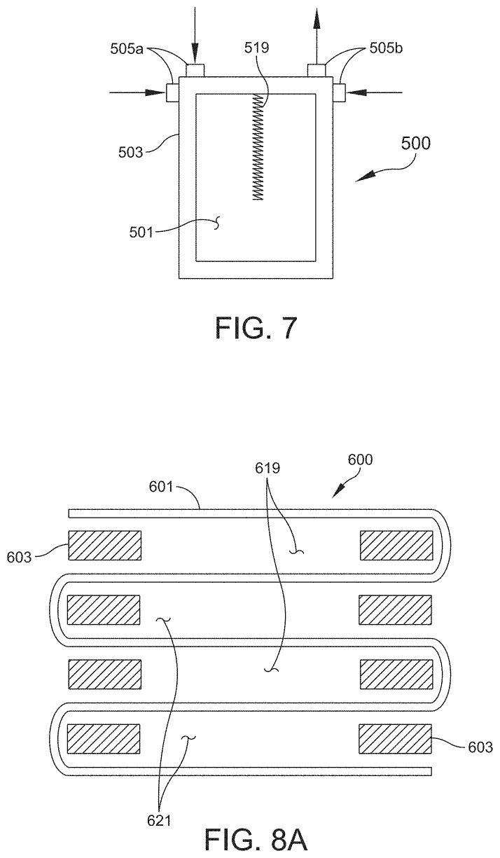

FIG. 6F is an enlarged cross-sectional view of a portion (e.g., the top header) of the frame 403, although this could be any of the frames described herein. A passageway 441 is drilled through the frame header 403-1, an end of which can be threaded to form at least one of the ports 405. Additional passageways 443 can be drilled that intersect the main passageway 441 and provide fluidic communication between the passageway/ports and the interior of the module. FIG. 6G depicts an alternative header 403-1, where there are two passageways 441a, 441b drilled from each end, but they do not intersect. There will also be a set of additional passageways 443a, 443b connecting each passageway 441a, 441b to portions of the interior of the module. This configuration can be used to provide the inlet and outlet ports for a module arrangement such as that shown in FIG. 7.

FIG. 7 depicts an alternative membrane module 500, where the ports 505a, 505b are located on the same side/surface of the frame 503. In this case, the ports 505a, 505b are located on the top header of the frame 503; however, the ports can be located on any surface to accommodate a particular application, for example, on the side near the top header as alternatively shown. In addition, the module 500 includes at least one glue line or seam 519 (or other structure) running vertically along the membrane 501 for controlling the flow of the solution through the module 500. In this case, the seam is centrally located on the membrane 501. The number, location, and orientation of the seam(s) 519 and the number and location of the ports 505a, 505b will be coordinated to suit a particular application. For example, if the ports 505a, 505b were located on the side of the frame near the center, the seam 519 could be oriented horizontally. Also, additional seams 519 could be used to extend the dwell time of the solution in the module 500.

FIGS. 8 and 8A depict another alternative module 600 that uses multiple frames 603 and a single, continuous membrane sheet 601. The frames 603 can be similar to any of the frames previously described and the membrane sheet 601 can be attached thereto in any of the manners also previously discussed. Generally, and as best shown in FIG. 8A, the membrane sheet 601 is “wrapped” around the frames 603 in a serpentine fashion, thereby forming feed channels 619 and permeate or draw channels 621. In addition, the module 600 can include any number and combination of the spacers and protective layers to suit a particular application. As shown in FIG. 8, the module 600 can include a plurality of ports 605 that can correspond to the plurality of channels. For example, in the case of an open module disposed within a feed tank, the ports can be the inlets and outlets to the permeate channels. In alternative embodiments, the module 600 is at least partially enclosed within a housing and includes ports corresponding to both the feed and permeate channels. In various embodiments, the multiple ports can be disposed within a manifold that is attached to one or more modules or is formed as part of the frames.

Generally, the channel widths will be selected to suit a particular application, e.g., flow requirements, dimensions of spacers, etc. and will typically be determined by the dimensions of the frames. In one or more embodiments, the draw channels are about 0.010 to about 0.50 inches thick, preferably about 0.018 to about 0.060 inches thick. In one embodiment, the frame is about 0.034 inches thick to accommodate a 0.034 thick spacer. The feed channels may have similar dimensions (although are typically larger) and are generally sized to provide room for the flow of feed solution and possibly provide space for substances that may precipitate out of the solution. In the case of multiple single modules disposed, for example in a tank, the feed channel spacing will be determined by the placement of the modules within the tank and the draw channel spacing (i.e., module interior space) will be determined by the spacers and any necessary protective layers.

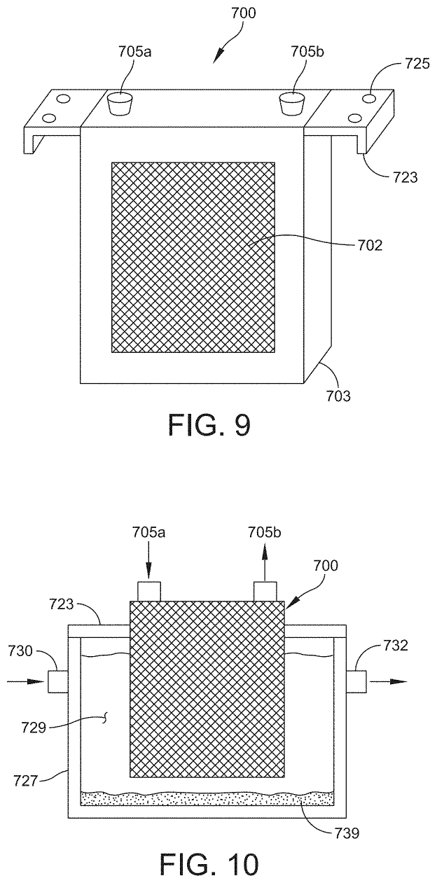

FIG. 9 depicts yet another alternative membrane module 700. Generally, the module 700 can have a similar construction as the modules previously described. As shown in FIG. 9, the module includes a protective screen 702. The screen 702 can be a mesh sheet or a more rigid type of grating that can be located on the two external faces of the frame 703. In the case of a stack of multiple membrane modules 700, the screen 702 can be located on only the exposed external faces of stacks. Generally, the screen can be used to protect the membrane from being “blown-out” in the case of a higher pressure on one side of the membrane versus the opposite side. For example, in the case of a module(s) disposed within an open tank (see FIG. 10), the solution therein is at atmospheric pressure and the solution introduced into the module is under pressure, typically a low pressure, but still higher than that of the open tank, which tends to cause the membranes to bulge outwardly. In additional embodiments, the screen can be used to protect the outer surface of the membrane from damage, for example, from contact with a sharp structure or large particles.

The module 700 can also include means 723 for attaching or otherwise securing the module to a tank or other modules. In one embodiment, the means for attachment 723 are arms that extend from the frame and include receptacles and/or protuberances that correspond to similar structures on the tank. In one embodiment, the attachment means 723 are simple hooks for engaging the tank sidewalls. The attachment means 723 can be constructed as part of the frames 703 or be optional pieces that can be attached to the frames. In one or more embodiments, the attachment means 723 can include hardware 725, such as mechanical fasteners or clamps, that assist in securing the modules to the tank or one another or, in some cases, the attachment means 723 to the frames/modules. Additionally or alternatively, the tank may include structure (e.g., baffles or other protuberances) for maintaining a membrane module within the tank in a specific orientation and/or secure the module thereto.

FIG. 10 depicts a module and tank arrangement that can use any of the modules described herein. As shown, the tank 727 is an open feed tank containing a feed solution 729, for example, seawater, brackish water, etc. from which solvent is to be extracted. The tank 727 includes one or more forward osmosis membrane modules 700 at least partially submerged therein. The tank 727 can also include ports 730, 732 for circulating feed solution therethrough. Draw solution having an osmotic pressure greater than the feed solution is pumped through the module(s) to draw the solvent from the feed solution through the membranes and into the draw solution, diluting same. Generally, the tank is sized and designed to suit particular system requirements, such as flow, flux/membrane area, and environment. In some cases, the tank can be sized so that there is room below the modules for contamination or other substances within the feed solution to settle out 739. The open tank and module design allows for easy maintenance of the system. For example, individual modules can be removed from the tank for maintenance or replacement, while the remaining modules can continue to operate. In some embodiments, the module ports are separately plumbed; however, in some embodiments, the ports may be in fluid communication with a common manifold arrangement.

In alternative embodiments, the tank has a closed design, which allows for the pressurization of the solution (e.g., feed solution) within the tank. This can assist the overall process by increasing the flux through the membranes and can reduce or eliminate any issues with the membranes bulging under the pressure of the solution (e.g., draw solution) within the membrane module. Alternatively or additionally, the (draw) solution can be “pulled” through the membrane modules under vacuum.

FIG. 11A is a partial exploded cross-sectional view of an arrangement of layers that may form one of the previously described membrane modules or may be used in a spiral wound configuration as shown in FIG. 11B. As shown in FIG. 11A, the arrangement starts with a membrane sheet 851, a feed screen 853 disposed adjacent one side of the membrane sheet 851 (in some cases disposed within a fold of the membrane sheet 851), and a permeate carrier 855 (or draw screen) disposed on the other side of the membrane sheet 851 (or folded about the folded membrane sheet 851). The membrane 851 is shown as a single sheet folded as would be the typical arrangement if used in a spiral wound membrane module; however, it is possible to layer single sheets if used in a plate and frame type arrangement.

The membrane 851 has a feed side that typically corresponds to the membrane barrier layer and a permeate side that typically corresponds to the membrane support layer. Typically for a forward osmosis application, the feed side is at a higher pressure than the draw side, which tends to push the membrane away from the feed and into contact with the draw screen. (For a PRO application, the draw side, which would then be the barrier layer side of the membrane, would be at the higher pressure) In the case of very thin membranes, and in particular those that have a very thin support layer such as those made in accordance with the present assignee's commonly owned U.S. Pat. No. 8,181,794, the high points on the surface of the draw screen can pierce the support layer and barrier layer and damage the membrane, especially in the spiral wound configuration. Generally, the feed and draw screens 853, 855 are relatively porous and resilient as they need to maintain the spacing between layers of membrane. As such, it is not possible to replace or eliminate the draw screen, and an additional protective layer 857 is necessary between the draw screen 855 and the membrane sheet 851. However, the protective layer 857 must balance protecting the fragile membrane 851 and not impeding flux or the flow of draw solution.

In one or more embodiments, the protective layer is a nonwoven fabric layer having a thickness of about 1.5 mils to about 20 mils, preferably about 5 mils to about 15 mils, and more preferably about 7 mils to about 10 mils. The layer is typically made of PET; however, other polymers that are compatible with the various solutions are contemplated and considered within the scope of the invention. In addition, the protective layer 857 will have a basis weight of about 50 to 100 g/m², preferably about 60 to 80 g/m², and more preferably about 70 to 75 g/m² and a Frazier air permeability of about 100 to 1000 cfm/ft², preferably 200 to 500 cfm/ft², and more preferably about 350 to 400 cfm/ft². In one or more embodiments, the draw screen has a thickness of about 10 mils to about 60 mils, preferably about 20 mils to about 40 mils and more preferably 34 mils (i.e., 0.034 inches), with a strand spacing of about 8-24 strands per inch (SPI), preferably 12-20 SPI, and more preferably 18 SPI with a strand orientation angle of about 90 degrees. In one or more embodiments, the feed screen has a thickness of about of about 10 mils to about 60 mils, preferably about 20 mils to about 40 mils and more preferably 20 mils (i.e., 0.020 inches), with a strand spacing of about 8-24 SPI, preferably 12-20 SPI, and more preferably 16 SPI with a strand orientation angle of about 90 degrees. The screens 853, 855 are typically made of polypropylene; however, other compatible polymers are also possible.

FIG. 11B depicts how the membrane assembly 850 (membrane and the various other layers) would be oriented in one possible spiral wound configuration. Typically, the membrane assembly is wound around a center tube 859 continuously for the length of the membrane assembly 850, with the various layers alternating as shown. As shown in FIG. 11B, there is a draw screen layer 855, a protective layer 857, a membrane layer 851, a feed screen layer 853, another membrane layer 851, another protective layer 857, another draw screen layer 855 and so on out from the center tuber 859.

Various components of the modules can be manufactured from a variety of materials including, for example, polymers, polymer blends, and block co-polymers and can be manufactured by, for example, molding, extrusion, stamping, or other known manufacturing techniques. The various membrane sheets can be manufactured from any suitable materials, such as those disclosed in U.S. Patent Publication Nos. 2007/0163951, 2011/0036774, 2011/0073540; and 2012/0073795; the disclosures of which are hereby incorporated by reference herein in their entireties. The particular materials used will be selected to suit a particular application and should be able to withstand the various process conditions, for example, high temperatures, and for fluid compatibility.

The overall size and number of membrane modules and membranes will be selected to suit a particular application with a focus on providing a specific total membrane surface area. In addition, the membrane parameters will also be selected to suit a particular application with a focus on obtaining a particular flux rate, where flux (JW)=A (Δπ−ΔP), where A=specific permeability (m/s/atm); Δπ=osmotic pressure difference at surface of membrane selective layer, and ΔP=pressure across membrane. The flux rate will also be impacted by the flow rates of the draw and feed solutions, which will be chosen to maximize residence time, but minimize concentration polarization (CP). In one example, an assembly having 50 membrane modules, each having an active membrane area of about 1′ by 3′ (3 ft²) will result in an approximate total effective membrane surface area of 150 ft². If used, for example, with a thin film composite polyamide membrane designed for osmotically driven flux, a flux of approximately 1500 gallons per day would be expected from an assembly of this type used in a seawater desalination environment with an average flux of about 10 gallons per ft² per day (GFD).

One example of a suitable membrane is disclosed in the incorporated U.S. Pat. No. 8,181,794. The membrane disclosed therein can be further enhanced by, for example, using polyethersulfone support structures, which may produce a different pore structure and provide improved flux/rejection properties in FO or RO applications. Additionally, the charge on one of the membrane layers, for example, the barrier layer, can be changed, which may also improve the performance of the membrane. Also, the various layers of the membrane can be modified by the incorporation of nanoparticles or anti-microbial substances. For example, layered double hydroxide (LDH) nanoparticles can be incorporated into the barrier layer to improve the flux/rejection characteristics of the membrane. These various modifications may also improve the reverse salt flux performance of the membrane. Additionally, these various improvements are also applicable to hollow fiber type membranes.

In one or more embodiments, the membrane includes a LDH in the form of MgₙAlₙ₋₁ (OH)₂. The ratio of Mg to Al may be about 1:1 to about 10:1, preferably about 2:1 to about 5:1, and more preferably 3:1; however, the specific ratio will be selected to suit a particular application. In some embodiments, the nanoparticles are organo-metallic compounds. This particular composition is represented in FIG. 12 and creates a membrane with an anionic clay layer (although cationic clay is also possible). In a particular embodiment, the general formula for the nanoparticle is as [Mg₍₁₋ₓ₎ Alₓ (OH)₂]q [An−q/n*mH₂O] where A is for anions, which could have both organic and inorganic nature. This layer can produce a charge proximate the junction between the membrane support layer and the membrane barrier layer that can preferentially reject solutes, resulting in the reduction or elimination of reverse flux of certain solutes. Furthermore, the addition of these nanoparticles can also improve the overall performance characteristics of the membrane. See, Table 1 for exemplary test results of a membrane comprising the inventive nanoparticles.

TABLE 1

| Chemistry | Rejection, % | RO Flux, GFD | FO flux, GFD |
|---|---|---|---|
| mPD/TMC | 98.8 | 11.9 | 9.1 |
| mPD/LDH/TMC | 98.2 | 11.9 | 12.0 |

RO test: 2000 ppm NaCl, 225 psi/25° C.
FO test: DI water feed, 1.5M NaCl draw

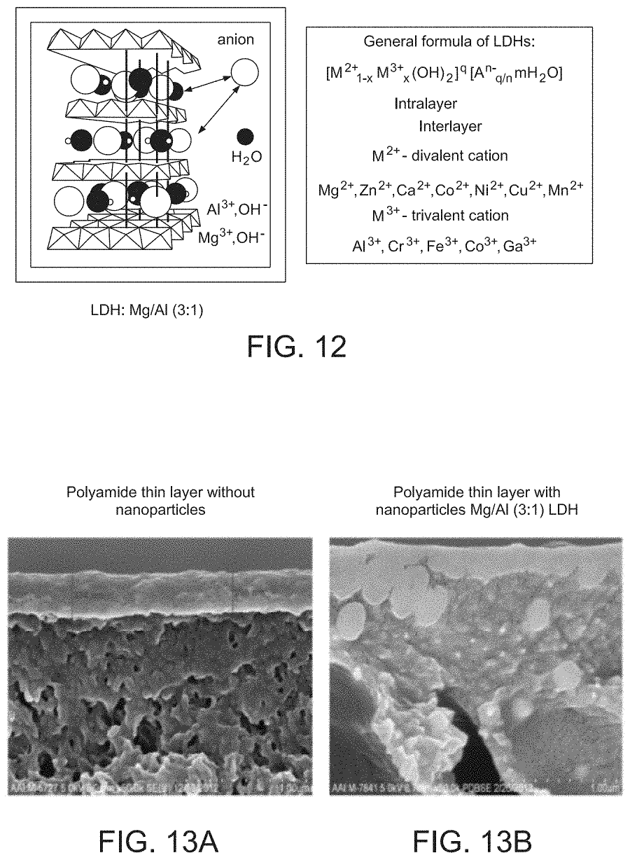

FIGS. 13A and 13B are SEM images of membranes with and without the inventive nanoparticle compositions.

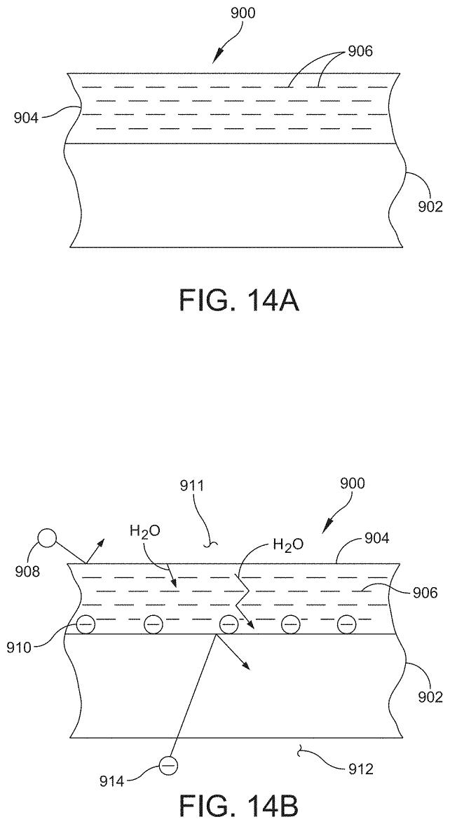

FIG. 14A depicts an enlarged, cross-sectional portion of one embodiment of a membrane 900 manufactured in accordance with the invention. Specifically, the support layer 902 and the barrier layer 904 are shown. In one or more embodiments, the barrier layer 904 ends up including a polyamide and the LDH nanoparticles 906 generally evenly dispersed within the barrier layer. As discussed below, there are various means that can be used to assist in controlling the dispersion of the nanoparticles within the barrier layer. The particular dispersion pattern of the nanoparticles can be used to help control the performance of the membrane.

FIG. 14B depicts another example of the membrane of FIG. 14A; however, the focus is on the charge added or modified by the introduction of the nanoparticles and the function of the membrane 900. As shown, the nanoparticles 906 within the barrier layer 904 create a charge 910 proximate the juncture of the barrier layer 904 and the support layer 902.

Typically, there is a feed solution 911 on one side of the membrane 900 and a draw solution 912 on the other side. Solvent (e.g., water) will flux through the barrier and dilute the draw solution 912. Solutes 908 within the feed solution 911 are generally rejected by the barrier layer. Generally, in prior art systems, solutes from the draw solution will attempt to reverse flux through the membrane into the feed solution. With the additional charge at the juncture between the barrier layer 904 and the support layer 902, certain of the solutes 914 within the draw solution 912 will be repelled/rejected by the charge provided by the nanoparticles. In the embodiment shown, the nanoparticles provide a negative charge; however, other nanoparticle compositions can be used to provide a positive charge to preferentially reject other solutes 914. Additionally, certain support layer materials can also be selected to provide a charge therein, which can be cumulative with the charge of the nanoparticles to provide a particularly strong rejecting force. For example, a polyethersulfone, which is more hydrophilic, may give a greater negative charge, which will be additive to the charge of the nanoparticles, thereby creating a double electrical layer. Generally, the membrane materials, draw solutes, and membrane charge can be selected to suit a particular application.

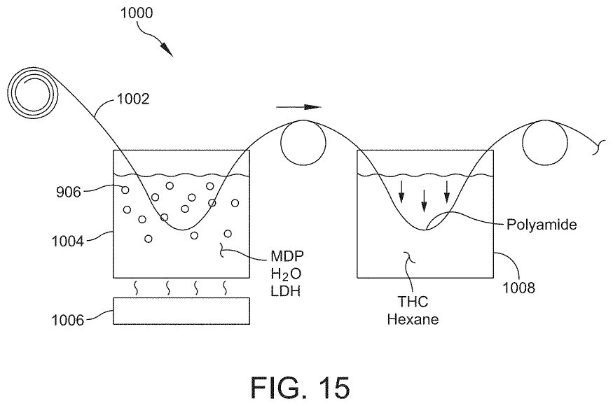

FIG. 15 depicts a portion of one possible process 1000 for producing a membrane in accordance with the invention. As shown in FIG. 15, a sheet of support material 1002 (typically a substrate with a thin support layer cast thereon) is feed (typically via a roll) through a first bath 1004 that contains a solvent (e.g., mDP) in solution with a first monomer and at least the nanoparticles 906. Other components may also be included in the bath 1004 to enhance or otherwise influence the process. Generally, the solvent is at least partially absorbed within the support layer depositing the nanoparticles on top of the support layer. The bath may include means 1006 for enhancing or controlling the dispersion of the nanoparticles within the solution and in the final barrier layer. The means 1006 can include the use of ultrasound (or other mechanism to impart vibratory forces on the nanoparticles), heat, an electrical signal, electro-magnetic energy (including UV, sound, or radio waves), and the introduction of surfactants or catalysts to the solution. Generally, the size and shape of the nanoparticles can be controlled to suit a particular application, and in exemplary embodiments are about 100 to about 250 nm. Ideally, the nanoparticles are formed as “flakes,” which may enhance the alignment of the nanoparticles within the barrier layer (e.g., a parallel alignment as generally depicted in FIGS. 14A and 14B). Additionally, the nanoparticles may also be formed having a dipole structure, which can further assist in the dispersion/alignment of the nanoparticles within the barrier layer (e.g., by the introduction of an electrical signal to the first bath and/or the support layer. Generally, it is desirable to prevent the nanoparticles from stratifying on the top or bottom of the layer.

The support layer 1002 is then feed through a second bath 1008 having THC in solution with hexane or Isopar G, although other solvents are contemplated and considered within the scope of the invention. The introduction of the monomer from the first bath with the monomer of the second bath creates the polymeric barrier layer (e.g., polyamide) with the nanoparticles at least partially dispersed therein and fixed in place. The membrane (support layer and barrier layer) can then be directed to additional, conventional processes (e.g., wash, quench, etc.) to complete the membrane manufacturing process.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in any claims. Further, acts, elements, and features discussed only in connection with one embodiment are not intended to be excluded from a similar role in other embodiments.

Furthermore, those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that the invention may be practiced otherwise than as specifically described.

What is claimed is:

1. A forward osmosis membrane module comprising:
a membrane sheet comprising at least a support layer and a barrier layer disposed thereon, the membrane sheet configured for passing a solvent therethrough via forward osmosis principles;
a first mesh screen disposed adjacent to the barrier layer of the membrane sheet;
a second mesh screen disposed proximate the support layer of the membrane sheet; and
a protective layer disposed between the second mesh screen and the support layer of the membrane sheet; thereby reducing or eliminating contact between the second mesh screen and the support layer of the membrane sheet.

2. The membrane module of claim 1, wherein the protective layer comprises a nonwoven fabric layer having a thickness of about 1.5 mils to about 20 mils.

3. The membrane module of claim 1, wherein the protective layer comprises polyethylene terephthalate.

4. The membrane module of claim 1, wherein the protective layer comprises a basis weight of about 50 to about 100 g/m².

5. The membrane module of claim 1, wherein the protective layer comprises a Frazier air permeability of about 100 to about 1000 cfm/ft².

6. The membrane module of claim 1, wherein the first mesh screen has a thickness of about 0.020 inches with a strand spacing of 16 strands per inch and a strand orientation of 90 degrees.

7. The membrane module of claim 1, wherein the second mesh screen has a thickness of about 0.034 inches with a strand spacing of 18 strands per inch and a strand orientation of 90 degrees.

8. The membrane module of claim 1, wherein at least one of the first mesh screen, the second mesh screen or the protective layer are secured to the membrane sheet via an adhesive.

9. A membrane assembly comprising:
a forward osmosis membrane module comprising:
a membrane sheet comprising at least a support layer and a barrier layer disposed thereon, the membrane sheet configured for passing a solvent therethrough via forward osmosis principles;
a first mesh screen disposed adjacent to the barrier layer of the membrane sheet;
a second mesh screen disposed proximate the support layer of the membrane sheet;
a protective layer disposed between the second mesh screen and the support layer of the membrane sheet; thereby reducing or eliminating contact between the second mesh screen and the support layer of the membrane sheet; and
a housing at least partially enclosing the forward osmosis membrane module and comprising means for fluid ingress and fluid egress.

10. The membrane assembly of claim 9, wherein the means for fluid ingress comprise a first inlet for introducing a feed solution to one side of the membrane module and a second inlet for introducing a draw solution to an opposite side of the membrane module.

11. The membrane assembly of claim 9, wherein the means for fluid egress comprise a first outlet for discharging a concentrated feed solution from one side of the membrane module and a second outlet for discharging a dilute draw solution from the opposite side of the membrane module.

12. The membrane assembly of claim 9, wherein the housing comprises a pressure vessel and the membrane module is wrapped around a center tube to form a spiral would membrane assembly.

13. A forward osmosis membrane with improved rejection characteristics, the membrane comprising:
a substantially planar substrate;
a polymeric support layer disposed on the substantially planar substrate; and
a polymeric barrier layer disposed on the polymeric support layer, the barrier layer comprising a plurality of layered double hydroxide nanoparticles substantially evenly dispersed within the barrier layer.

14. The membrane of claim 13, wherein the layered double hydroxide nanoparticles comprise flakes of Mg/Al-LDH.

15. The membrane of claim 14, wherein the nanoparticle flakes comprise a longitudinal axis and the longitudinal axes are oriented horizontally relative to the barrier layer.

16. The membrane of claim 13, wherein the layered double hydroxide nanoparticles comprise Magnesium and Aluminum in a ratio of about 1:1 to about 10:1.

17. A method of manufacturing a forward osmosis membrane, the method comprising the steps of:
providing a substantially planar substrate;
casting a polymeric support layer onto the substantially planar substrate; and
casting a polymeric barrier layer onto the polymeric support layer, wherein the barrier layer comprises a plurality of layered double hydroxide nanoparticles substantially evenly dispersed within the barrier layer.

18. The method of claim 17, wherein the step of casting the barrier layer comprises the steps of:
introducing the layered double hydroxide nanoparticles into a solvent bath comprising a first monomer;
introducing the substantially planar substrate and support layer to the solvent bath;
subjecting the substantially planar substrate and support layer to means for dispersing the layered double hydroxide nanoparticles;
introducing the substantially planar substrate and support layer to a second bath, wherein the second bath comprises a second monomer; and
reacting the monomers to form the barrier layer and set the nanoparticles in place within the barrier layer.

19. The method of claim 18, wherein the means for dispersing comprise subjecting the solvent bath to ultrasonic waves.

20. The method of claim 18, wherein the means for dispersing comprise subjecting the solvent bath to electro-magnetic energy.
